(19) United States
(12) Patent Application Publication
(10) Pub. No.: US 2010/0187400 A1
(43) Pub. Date: Jul. 29, 2010

(54) SOLAR ANTENNA

(75) Inventor: Ivano Mazzarotto, Maniago (IT)

Correspondence Address: BUCKNAM AND ARCHER, 1077 NORTHERN BOULEVARD, ROSLYN, NY, 11576, US

(73) Assignee: PROJECT S.R.L., Maniago (IT)

(21) Appl. No.: 12/450,814

(22) PCT Filed: Jun. 13, 2007
(86) PCT No.: PCT/IT2007/000415

§ 371 Date: Mar. 18, 2010

(30) Foreign Application Priority Data
Apr. 14, 2007 (IT) PN2007A000021

(51) Int. Cl. G02B 5/10; G01J 1/20; B23P 11/00

(52) U.S. Cl. 250/203.4; 359/853; 29/428

(57) ABSTRACT

A solar antenna having a parabolic reticular structure (1), which represents a solar ray concentration device, which is provided with heliostats (8) and with a solar concentration point (26); devices are provided which are adapted to define a dimensionally reduced and substantially less cumbersome dimensional shape during transportation. The antenna includes two sub-structures (3,4), which are provided with a distinct articulation adapted to define a dimensionally reduced and substantially less cumbersome shape during its transportation.

The present invention relates to a solar antenna, comprising a reticular parabolic structure, said structure being adapted to substantially represent a solar rays concentration device, said device being provided of a plurality of mirror-like surface plane heliostats, automatic means being provided in correspondence of a focal point of said structure in order to optimize the reception of solar rays from said structure, depending on sun movement.

If the coal influenced the first industrial revolution, the coal oil influenced the 20th century one, whereas the renewable sources exploit should be called to distinguish the third industrial revolution.

From hydroelectric power till solar one, from wind power till geothermic one and till biomasses, the percentage of renewable power into the mix of power production, could increase in the next 40 years from present 18% up to 34%.

The oil cost and environment pressure are influencing the development of power obtained from unlimited and environment sustainable sources. In Japan and Germany, which are leader Countries in such a sector, the percentage of solar power increased about yearly 31%. German Government would reach the 20% ratio of renewable power within 2020 year.

In such a year Norway would become the first Nation with no oil consumption. Thanks to 200 square meters/inhabitants of solar panels, Germany created a photovoltaic industry with 25,000 employers, 5,000 companies and £0.2 billions of income.

As for Italy, it could be possible create a model of virtuous development, where research of alternative solutions could harmonize economic and environment growth A push towards a take off of a power production into the renewable sources could arrive in Italy from the program, ensured by government, which couples innovation funds with environment incentives.

An opportunity could be opened, in order to stimulate research on several fronts, as no technology, taken as alone, may be sufficient. A mix of renewal powers should be pointed out, according to national requirements.

It's known that European Union set the target to spare since the present year 1% of power consumption up to next six years,. Such a target should be increased to 1.5% relating to the public sector. As for Europe, power relating to heating, air-conditioning and lightning consumption of buildings, represents 40% of total power consumption and is satisfied thanks of fossil combustible.

Such a statement proves how the solar power is worth. The solar panel devices result to represent the most used solutions in the solar field, almost for economical reasons with reference to different solutions.

Sophisticated and therefore more expensive solutions are represented by solar power converters directly to electric power. They are practically photo-voltaic panels.

As already explained, updated technologies on the market allow to utilize solar power according to a plurality of methods, for which it is obvious that their installation costs, as well as their life, their reliability, and their maintenance costs represent their preference index expressed by families and builders of homes, offices and plants.

It should be repeated that the most solar power devices are represented by solar panels both thanks to their low sale price as well as their low installation cost.

Otherwise, solar panels present a series of limitations and drawbacks of solar power exploitation, among them:
1) their high thermal inertia, i.e. a substantially long time, also in terms of hours, for instance at the day beginning or every time they are restarting, before that solar panels supply water sufficiently warm for different requirement;
2) a quite low efficiency in terms of a power results, in the sense that, whenever sky is covered by clouds or during cold season s, solar panel is lowly exploiting solar energy, as well as the solar energy is practically exploiting not more that 50% as the device is fixed;
3) as soon as, especially during summer, solar panel reaches maximum temperature degrees, safety reasons oblige water discharging operations in order to avoid damages.

A question is practically arising: “Why industries and market didn't yet sufficiently care development of such a device, whereas other devices, e.g. solar panels, were development?”

The answer id quite simple: It is not known that any industries were up to now interested in such a operation, at least in Italy, with the result that no technical economical evaluation of problems connected to overall dimensions of device, especially for its transport, particularly of parabolic structure, as well as to a substantially reliability in various atmospheric dimensions.

Consequently, the small industries which were interested in the field of solar antennas, quite soon renounced to development of such a project, also due to cost, dimension and aesthetic competition of solar panels.

As for university research centres, they are still involved in such solar panels, relating to utilization of photo voltaic high concentration power, which is produced by solar antenna according to the invention. Said research centres are not involved in the solar antenna simplification, in its working, as well in the problems connected to their engineering, and at last in their marketing.

Therefore, the problems, which the solar antenna intends to solve, are regarding:
1) the possibility to realize the plant according to the invention of innovating type, as well as under the profile not only relating to its performance and its working, but also of its production costs and therefore of its sale price;
2) the opportunity to foreseen a plant adapted to produce:
   a) hot water for sanitary use;
   b) (medium temperature) hot water for ambient heating;
   c) (high temperature) hot water for industrial use;
3) the possibility to produce electric power due to photo-voltaic devices or due to electric motors Stirling type or similar;
4) the extension of solar antenna performances in the field of air conditioning devices. The main problems, which a solar antenna intends to solve are:
   at first the dimension problems, which solar antenna reaches (more than 3×4 meters) not only relating to transport and assembly, but also to reliability in critical atmospheric conditions, as well as to set to rest position, for instance during night or in special critical conditions;
   then, the solar antenna engineering should care a substantially simple assembly of some components,

Said problems are solved by solar antenna according to the invention, which is characterized by means adapted to define a dimensionally reduced and substantially less cumbersome dimension shape during its transportation.

A further problem is connected to the fact that solar antenna according to the invention is characterized by means adapted to provide such a device with a position adapted to defend and to ensure it against meteorological events.

Such and further characteristics will be apparent from the alleged description and from alleged design, where:

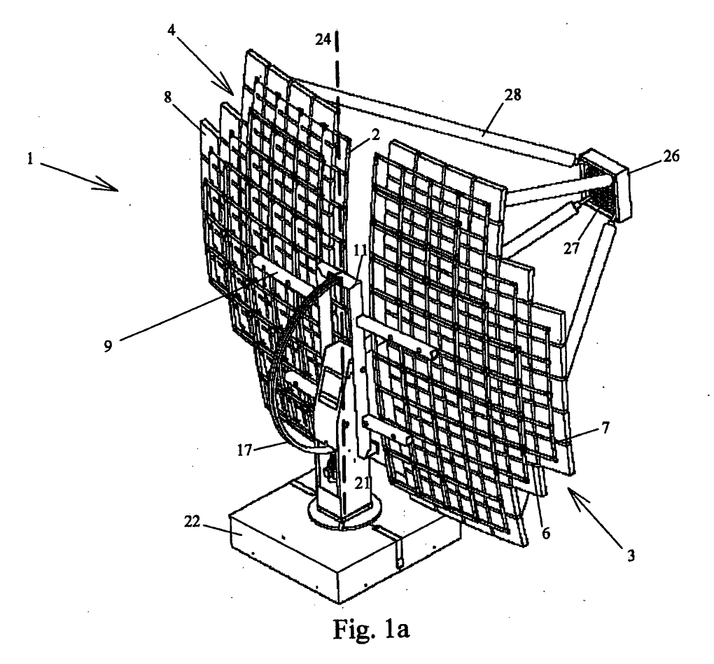

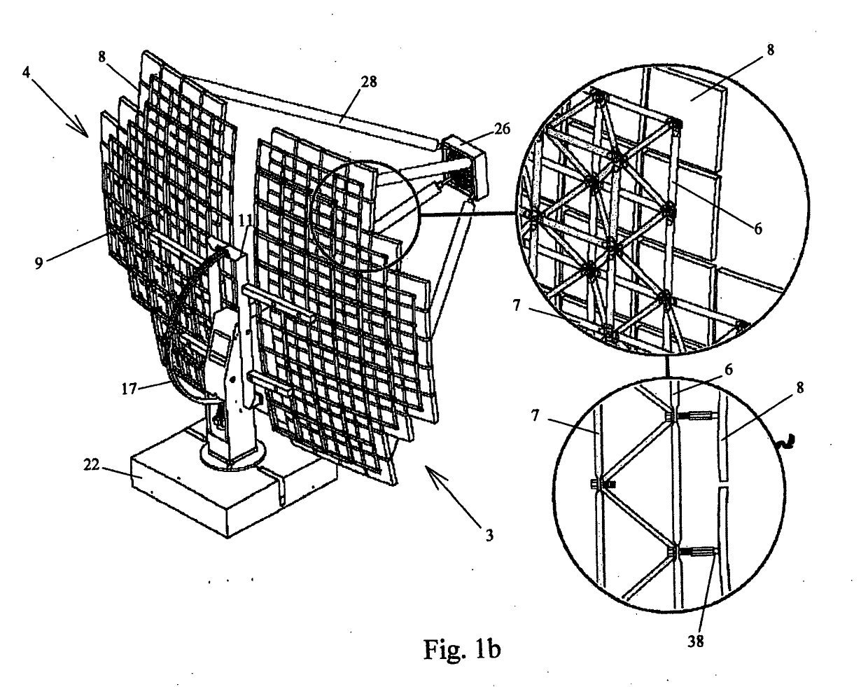

FIGS. 1a,1b represent respectively a perspective a view of the antenna according to the invention and a detail of such a reticular structure;

FIG. 2 represents a perspective view of load-bearing structure of said antenna;

FIG. 3 represents a side view of the reticular structure connected to a heliostat;

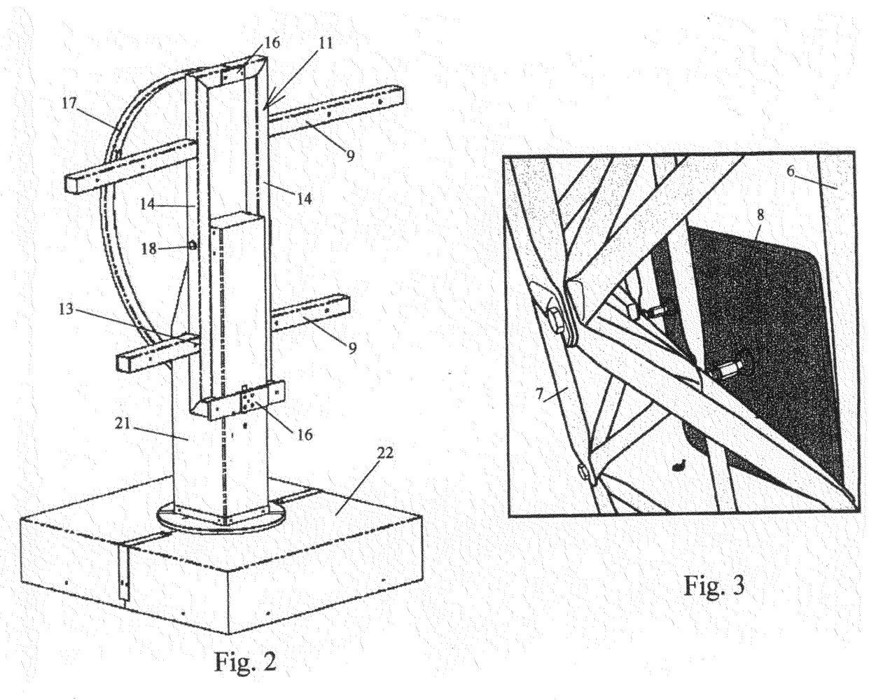

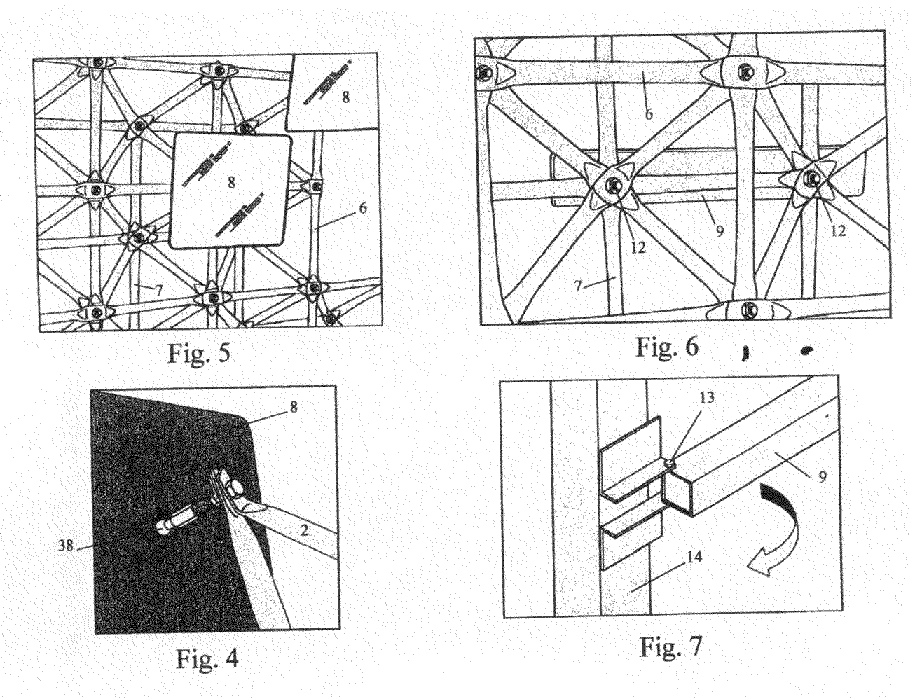

FIG. 4 represents a detail of a heliostat connection to the reticular structure of solar antenna;

FIG. 5 represent a front view of reticular structure and relevant heliostat;

FIG. 6 represents a front view of connection of reticular structure to the arms of a mobile support;

FIG. 7 represents a perspective view of a hinge o an arm of a mobile support;

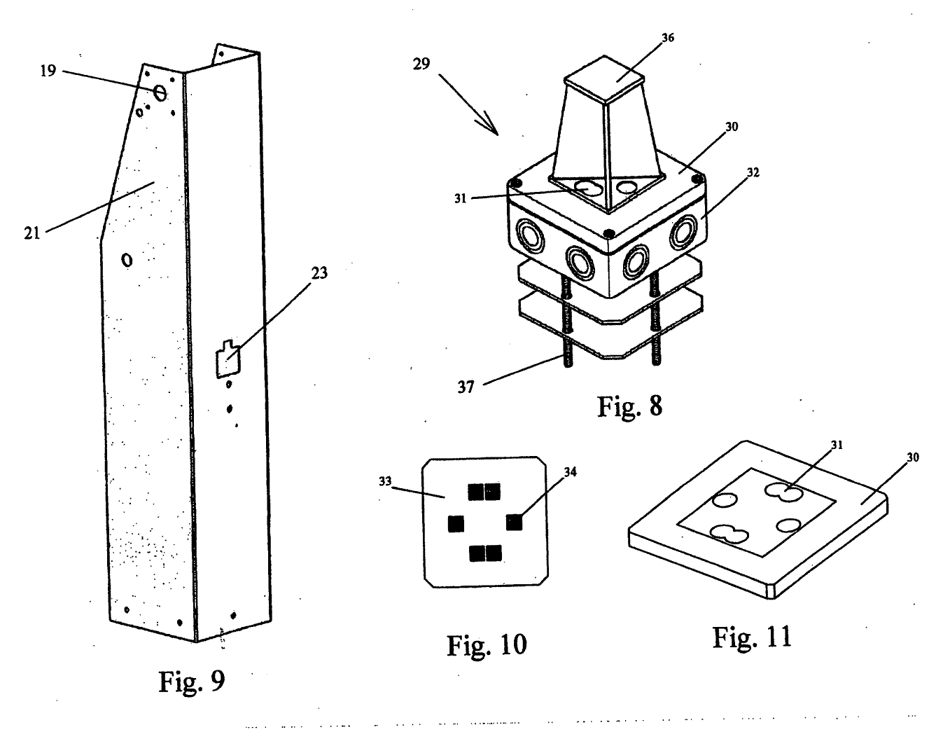

FIG. 8 represents of a perspective view of a pointer of the solar antenna;

FIG. 9 represents a perspective view of a support;

FIG. 10 represents u plant view of board adapted to contain a system of photo resistances;

FIG. 11 represents a perspective view of base cover.

The solar antenna according to the invention comprises a parabolic reticular structure 1 (FIGS. 1a,1b,3) made of aluminium elements 2, which are adapted to be assembled according to a substantially simple way.

Said structure comprises two respectively right 3 and left 4 sub-structures, with two parabolic vertical plans 6,7, where plan 6 is adapted to support a plurality of heliostats 8, whereas the rear plan 7 should strengthen the entire structure 1.

Said reticular structure 1 is made, as already explained, of said sub-structure 3,4, in the sense that, as it will be apparent later, a distinct articulation is provided, in such a way that the two sub-structures 3,4 could distinctly rotate.

Said solution could make easier the transport of solar antenna 1 from workshop to installation site, exploiting the possibility to reduce its size. Indeed, it is apparent that described solar antenna is adapted to dimensionally arrive up to over than 3×4 meters

Such a structure is mounted to four arms 9 of a mobile support 11 (FIGS. 1a,2,6), each one of said arms resulting fixed to some elements 2 of plan 7 by means of two bolts 12. Arms 9 are provided with hinges 13 (FIG. 7), which are adapted to connect according to a rotating way said arms 9 to support 11, so that, as it was early explained, antenna size could be reduced and, therefore, to make easier the transport.

Said mobile support 11 is adapted to assume a substantially rectangular shape, which is made by two vertical arms 14 and by two horizontal arms 16, which are welded each to the other. In correspondence of two arms 16 middle, a fifth-wheel 17, which is adapted, as it be well explained forward, to allow, by means of a chain not represented in the drawings, a rotation of mobile support 11 around a pin 18, which is lodged in a hole 19 (FIG. 9) of a castle 21 fixed to a basement 22.

Two sub-structures 3,4, mobile support 11, arms 9, hinges 13, fifth-wheel 17 and castle 21 represent means adapted to define a dimensionally reduced shape and substantially less sized of said antenna during transportation.

Fifth-wheel 17 results in such a way adapted to confer the entire structure a rest position, as well as a protection, safety position against meteorological events. Castle 21 plays the following roles:
it allows fifth-wheel 17 (and therefore to the entire structure 1) to rotate mobile support 11 around a pin 18, allowing in such a way the fifth-wheel 17 to cross a hole 23 obtained inside castle 21;
it allows entire reticular structure 1 to rotate around a vertical axis 24 (FIG. 1), in order to allow said structure to follow sun path;
it allows to control, according to a way known per se, the movement of fifth-wheel (in order to control the optimal inclination of reticular structure 1 with respect to height of sun.)

Basement 22 should contain devices, which are adapted to control, in a way known per se, rotation of castle 21 around vertical axis 24.

Before parabolic structure 1, in correspondence of a focus 26, a coil 27 is placed, where a thermal-carrier fluid is adapted to flow, which should collect and transmit the sun heating, reflected by heliostats 8, so that the relevant heating can be utilized.

Focus 26 is supported by four arrows 28, two of which being adapted to contain duly insulated ducts, not represented in the drawings, so that thermal carrier fluid could circulate.

Solar antenna is provided with electronic pointer device 29, which should control operative antenna function (FIG. 8).

Said electronic pointer device 29 is placed about half height of parabolic structure 1, in a side position with respect of heliostats 8.

Said pointer device 29 is fixed to reticular structure 1 by means an aluminium element 2, similar to the elements 2, which represent reticular structure 1.

Pointer 29 is made of some components:
a base cover 30, provided with four holes 31 (FIGS 8,11);
a container 32, adapted to contain a board 33 (FIG. 10) with a brightness sensor made of photo resistances 34;
a brightness divider 36, which is placed on base cover 30;
a micrometric pointer adjustment device 37, which is placed below of container 32.

Pointer 29 is adapted to replace, for cost as well reliability problems related to traditional device, a photo cells system with a photo resistances system 34 (FIG. 10),. Said system 34 is adapted to produce resistances thanks to solar light, which enters four holes 31 of base cover 30 (FIG. 11). It is to be point out that photo cells were producing current in traditional plants.

Said resistances should, each one, be provided with the same value, whereby board 33 should emits in a way known per se, a signal to castle 21 in absence of relevant balance. Indeed, light with enters one of the holes 31, couldn't be the same of lights, which enter the remaining holes.

Thanks to said signal, castle 21 adapts with a rotation, reticular structure I should restore resistance balance.

A pointer 29 innovating performance given by the fact that said pointer is adapted to be assembled according to a substantially simple and automatic way. Indeed it is sufficient a substantial light pressure on cover 30, which could fix it on container 32.

Pointer 29 represents automatic means, which are provide in order to optimize solar rays from solar antenna in function of sun path.

Solar antenna according to the invention could appear according to different shapes, depending on assembled shape in workshop or installation by the user.

Heliostats 8 are screwed in a way known per se, on elements 2 of reticular structure 1 (FIG. 4). Their pointing toward focus 26, relating to its final adjustment, is manually operated by the user, thanks to a spherical articulated joint 38, which allows said adjustment.

Parabolic structure is manufactures thanks to assembling operation of a plurality of heliostats 8 on reticular structure 1 (FIGS. 1a,1b)

The assembly in workshop is made according to the following operations:
after assemblage of reticular structure 1, particularly of aluminium elements 2, the remaining elements (mobile support 11, castle 21, basement 22) are assembled;
reticular structure 1 is fixed to arms 9 of mobile 11 support thanks to the bolts 12;
on reticular structure 1 a pointer 29 as well as heliostats 8 are mounted according a provisional way;
so assembled, so mounted, structure 1 is prepared for transportation, through rotation of mobile support 11, which acts in order to make it acquire a horizontal position by means of a control of fifth wheel 17. The two sun-structures 3,4 are rotated thanks to hinges 13 of arms 9, and they acquire a vertical position. In such a way size is reduced and consequently transport is helped.

As well as the so assembled structure 1 arrives by the user, the process is developed according the following way
sub-structure 3,4 are subjected to a new opening, in the sense their first movement is given by their opening, with consequence that they are horizontally opened thanks hinges 13 of arms 9 and then, thanks to fifth-wheel 17, everything is vertically repositioned;
arrows 28 are now fixed on structure 1, so that coil 27 could be positioned in correspondence of focus 26;
heliostat 8 orientation is now controlled, so that their optimal angular position is restored;
pointer 29 is definitively mounted, taking into account that its orientation position with respect to sun is now definitively adjusted by acting on micrometric adjustment device 37. Said micrometric adjustment allows to obtain pointer 29 adjustment substantially simple and precise with respect to traditional operations.

Solar antenna according to the invention provides the presence of a safety device (anemometer), not represented in the drawings, which is adapted to put into a safety position the parabolic structure 1, said device being adapted to be manually or automatically controlled in a way known per se.

1. A solar antenna, comprising a reticular parabolic structure (1), said structure being adapted to substantially represent a solar rays concentration device, said device being provided with a plurality of mirror-like surface plane heliostats (8), automatic means being provided in correspondence of a focal point (26) of said structure (1) in order to optimize the reception of solar rays from said structure, depending on sun movement, and means (2,3,4,8,9,11,13,17,21) adapted to define a dimensionally reduced and substantially less cumbersome dimensional shape during its transportation.

2. The solar antenna as defined in claim 1, wherein said plurality of heliostats (8) are screwed on said reticular structure (1), their pointing on said focal point (26) being manually obtained by means of a spherical articulating joint (38).

3. The solar antenna as defined in claim 2, including two sub-structures (3,4), said sub-structures being provided with a distinct articulation, in such a way that they distinctly rotate, so as to substantially make easier the transport of the parabolic structure (1) exploiting the possibility to reduce the size of said structure (1).

4. The solar antenna as defined in claim 3, comprising a plurality of arms (9) of a mobile support (11), said arms (9) being provided with hinges (13), connecting said arms (9) to said support (11), so that antenna size can be reduced.

5. The solar antenna as defined in claim 4, including a fifth-wheel (17) adapted to confer the entire structure (1) a rest position, as well as a protection and safety position against meteorological events.

6. The solar antenna as defined in claim 5, further including a castle (21), adapted to control said fifth-wheel (17) and to allow the entire reticular structure (1) to rotate around a vertical axis (24) as well as to allow said structure to follow the path of the sun.

7. The solar antenna as defined in claim 6, further including automatic pointer means (29), provided so as to optimize the solar rays from said parabolic structure (61) as a function of sun displacement.

8. The solar antenna as defined in claim 7, further comprising a base cover (30), provided with four holes (31), a container (32), adapted to contain a board (33) with a brightness sensor (34) made of photo resistances, a brightness divider (36), placed on base cover (30), and a micrometric pointer adjustment device (37), placed below said container (32).

9. The solar antenna as defined in claim 8, wherein said pointer means (29) is adapted to be assembled according to a substantially simple and automatic way requiring a substantially light pressure on cover (30) in order to fix it on container (32).

10. The solar antenna as defined in claim 9, wherein said board (33), which is adapted to contain photo resistances (34), said resistances (34) being adapted to replace, for cost as well reliability problems a photo cells system with a photo resistances system (34).

11. Assembly process of the reticular parabolic structure (1), defined in claim 10, comprising the following phases in workshop:
components (2, 11 ,21 ,22) are assembled;
reticular structure (1) is fixed to arms (9);
on reticular structure (1) a pointer (29) as well as heliostats (8) are mounted according a provisional way;
so assembled, so mounted, structure (1) is prepared for transportation, through rotation of mobile support (11), which acts in order to make it acquire a horizontal position, by means of a control of fifth wheel (17), two sub-structures (3,4) are rotated thanks to hinges (13) of arms (9), whereby the size is reduced and consequently transport is helped.

12. Assembly definitive process of the reticular parabolic structure (1) defined in claim 10 by the user, comprising the following phases:
sub-structure (3,4) are subjected to a new opening, in the sense their first movement is given by their opening, with consequence that they are horizontally opened thanks to hinges (13) of arms (9) and then, thanks to fifth-wheel (17), everything is vertically repositioned;
arrows (28) are now fixed on structure (1), so that coil (27) can be positioned in correspondence of focal point (26);
heliostat (8) orientation is now controlled, so that their optimal angular position is restored;
pointer (29) is definitively mounted, taking into account that its orientation position with respect to sun is now definitively adjusted by acting on micrometric adjustment device (37).
